(19) United States
(12) Patent Application Publication
(10) Pub. No.: US 2016/0127758 A1
(43) Pub. Date: May 5, 2016

(54) METHOD AND SYSTEM FOR PRESENTING A SECOND VIDEO WITH ONE OR MORE FIRST VIDEOS BASED ON ONE OR MORE THRESHOLDS FOR TIME VIEWED

(71) Applicant: QDOS, INC. D/B/A DESKSITE, Irvine, CA (US)

(72) Inventor: Richard James Gillam, Irvine, CA (US)

(21) Appl. No.: 14/531,811

(22) Filed: Nov. 3, 2014

(51) Int. Cl. H04N 21/2668; H04N 21/231; H04N 21/81

(52) U.S. Cl. CPC H04N 21/2668; H04N 21/814; H04N 21/812; H04N 21/231

(57) ABSTRACT

A system and method for presenting a second video with presentation of a first video comprises a server connected to a network. The server comprising a processor, and a video management database in communication with the server. The video management database contains transformable electronic video management data. A video management software program is configured to present the first and second videos and transform the electronic video management data in the database depending on the presenting of the first and second videos for consumption by the viewer. A first set of instructions in the software program executable on the processor is for recording a duration of time for viewing of the first video by transforming the electronic video management data in the database to produce a recorded duration. A second set of instructions in the software program is executable on the processor for presenting the second video depending on the recorded duration.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention generally relates to a method and system for presenting a first video before or during one or more second videos based on one or more thresholds for time viewed. More specifically, the present invention relates to a system and method that transforms electronic data in a database, in real time, as a viewer watches one or more first videos to programmatically determine when a second video should be shown to the viewer.

### BACKGROUND

Videos presented on video playback sites are often interrupted or preceded by the presentation of videos that a content provider, advertiser or website owner desires a viewer to watch (herein after referred to as “second videos”). In exchange for watching these second videos, the viewer is rewarded with content the viewer desires to watch (herein after referred to as “first videos”). For example, websites such as CNN.com present second videos to an audience of viewers that may or may not want to see them, such as an advertisement. The viewer may be forced to watch all, or a minimum amount, of these second videos before first videos are presented to the viewer.

Furthermore, even if the viewer does not watch the entire first video that he or she desires, or only watches a comparatively short first video, he or she may still be presented with the same or different second video when he or she wishes to watch another first video; independent of how long they've been viewing first videos.

Prior art systems lack a virtually infinite degree of control over when second videos should be played relative to first videos and this represents a source of frustration for both content providers and viewers alike. Since viewers may not be getting a fair trade of their desired first videos in exchange for the length of time they spend watching potentially undesirable second videos they're likely to become frustrated. Moreover, due to the frustration generated by too many second videos playing relative to first videos, a decline in viewership is possible which would thereby negatively impact the content provider.

None of the previous video playback systems provide a suitable method to sufficiently transform second video content consumption (whether advertising or not) into a tolerable, controllable and dynamic reflection of first video content consumption. Furthermore, none of the previous systems, taken either singularly or in combination, anticipate or make obvious the instant invention as claimed. Thus, a combination that solves the aforementioned problems is desired.

### SUMMARY OF THE INVENTION

In order to solve the problems and shortcomings of the prior art, according to one preferred embodiment, a system for presenting a second video during, before, after or with presentation of a first video is comprised of: a server connected to a network, the server comprising a processor; a video management database in communication with the server, the video management database containing transformable electronic video management data; a video management software program configured to present the first and second videos and transform the electronic video management data in the database depending on the presenting for consumption by viewers of the first and second videos; a first set of instructions in the software program executable on the processor for recording a duration of time for viewing of the first video by transforming the electronic video management data in the database to produce a recorded duration; and a second set of instructions in the software program executable on the processor for presenting the second video depending on the recorded duration.

In another preferred embodiment, a system for presenting a plurality of second videos during presentation of a plurality of first videos is comprised of: a server connected to a network, the server comprising a processor; a video management database in communication with the server, the video management database containing transformable electronic video management data; a video management software program configured to present at least one of the first videos and at least one of the second videos, and to transform the electronic video management data in the database depending on the presenting of the at least one first video and the at least one second video; a first set of instructions in the software program executable on the processor for recording a duration of time for viewing of the at least one first video by transforming the electronic video management data in the database to produce a recorded duration; and a second set of instructions in the software program executable on the processor for presenting the at least one second video depending on the recorded duration.

In accord with another preferred embodiment, a method for presenting a second video during presentation of a first video is comprised of: storing a video management database in communication with a server, the video management database containing transformable electronic video management data; presenting the first and second videos and transforming the electronic video management data in the database depending on the presenting of the first and second videos; recording a duration of time for viewing of the first video by transforming the electronic video management data in the database to produce a recorded duration; and presenting the second video depending on the recorded duration.

In accord with another preferred embodiment, a system for presenting a plurality of second videos with presentation of one or more first videos, comprises: a server connected to a network, the server comprising a processor; a video management database in communication with the server, the video management database containing transformable electronic video management data; a video management software program configured to present at least one of the first and an n number of second videos, and to transform the electronic video management data in the database; a first set of instructions in the software program executable on the processor for recording a duration of time for viewing of the at least one first video by transforming the electronic video management data in the database to produce a recorded duration; and a second set of instructions in the software program executable on the processor for presenting each of the n number of second videos depending on the recorded duration.

### BRIEF DESCRIPTION OF THE DRAWINGS

FIG. 1 is a diagrammatic representation of an exemplary internet-based environment in which one embodiment may operate;

FIG. 2 is a diagrammatic representation of the components of one or more of the servers of FIG. 1;

FIG. 3 is a diagrammatic representation of one or more of the servers of FIGS. 1 and 2, and a storage device with a database containing electronic data that is transformed; and

FIG. 4 is a flow chart illustrating steps performed by a video display software according to the embodiment of FIGS. 1-3.

### DETAILED DESCRIPTION OF THE PREFERRED EMBODIMENTS

For the purpose of illustrating the invention, there is shown in the accompanying drawings several embodiments of the invention. However, it should be understood by those of ordinary skill in the art that the invention is not limited to the precise arrangements and instrumentalities shown therein and described below.

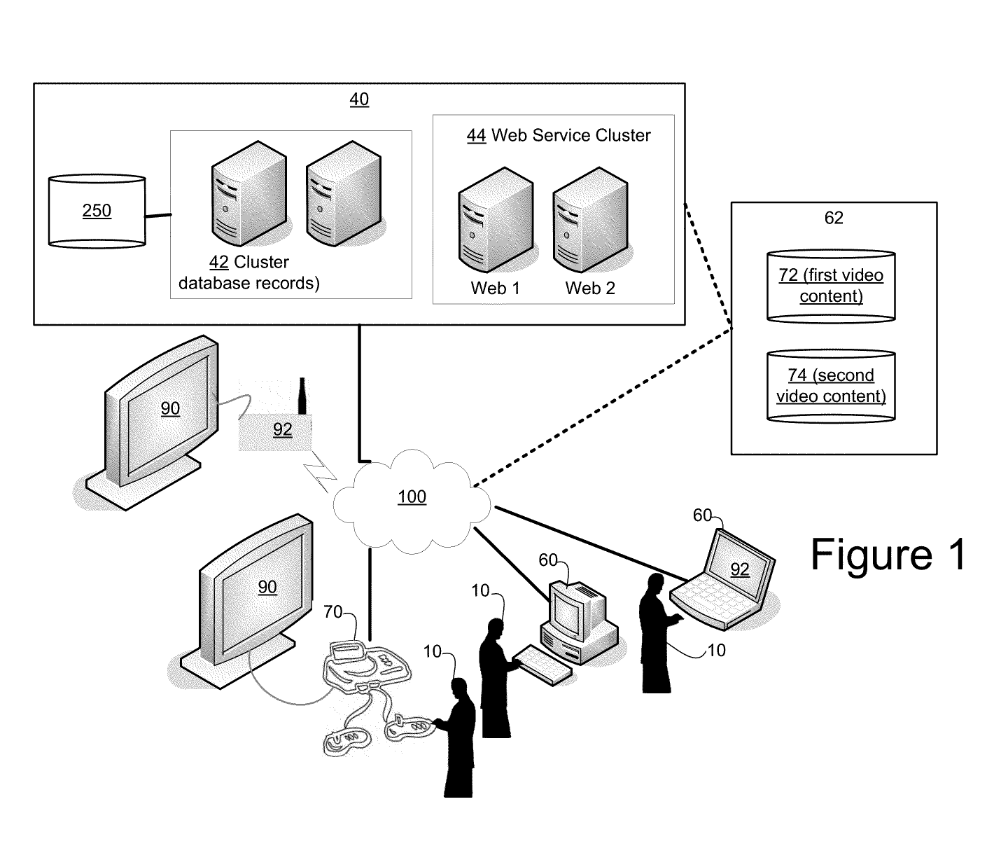

The system and method for presenting a first video within one or more second videos based on one or more thresholds for time viewed is disclosed in accordance with preferred embodiments of the present invention and is illustrated in FIGS. 1-4 wherein like reference numerals are used throughout to designate like elements.

With reference to FIG. 1, a diagrammatic representation of an exemplary internet-based system is shown in which the system and method may operate according to one embodiment. As is typical on today's internet 100, users 10 may connect to and use the internet 100 over several platforms. Those platforms may include personal computers 60, mobile phones, tablets, or the like. One of the latest ways to connect to the internet includes using internet protocol television, or IPTV, boxes 92. These IPTV boxes 92 include a wireless or wired device that has a memory and storage for applications or apps that connects to the internet 100. Through an IPTV box 92, users may use the apps contained therein to display videos, pictures, and internet sites on a television (TV) 90. The television is typically connected to the IPTV box 92 via an HDMI cord, component cable, or audio/video (A/V) input lines.

Further, modern game consoles 70 are now capable of video play. Game consoles 70 such as the XBOX®, Playstation®, Nintendo®, Wii®, and others, provide for internet video presentation. Just as with the IPTV box 92, game consoles 70 typically connect to a TV 90 on which the video may be viewed.

One or more servers 40 may include one or server clusters 42 and one or more web front end servers 44. One or more storage devices 250 may further be included. Further, within the server 40, or external to the server 40, one or more network video storage systems 62 may be included. The video storage system 62 may include a primary or first video storage device 72 and a secondary or second video storage device 74. For example, the first video storage device 72 may store a plurality of first videos that may be presented to users, and the second video storage device 74 may store a plurality of second videos that may be presented to users before, during or after the one or more first videos. By way of example, and not by way of limitation, the first videos may include user searchable videos for presentation to the users, and the second videos may include a plurality of advertising videos that may be presented within the presentation of the first videos. In one embodiment, instead of the first and second videos being stored in two storage devices, both the first and second videos may be stored in the same storage device, but, for example, in different folders for organizational purposes.

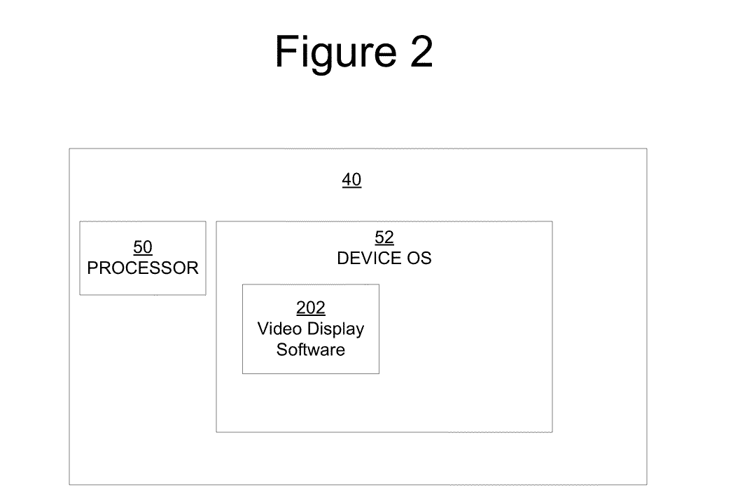

With reference to FIG. 2 a diagrammatic representation of the components of one or more of the servers of FIG. 1 is shown. Each server may include a processor 50, on which executable instructions of a computer program 202 may execute. As those skilled in the art would recognize the computer program 202, which may embody the video display software 202, may be loaded by an operating system 52 running on each server.

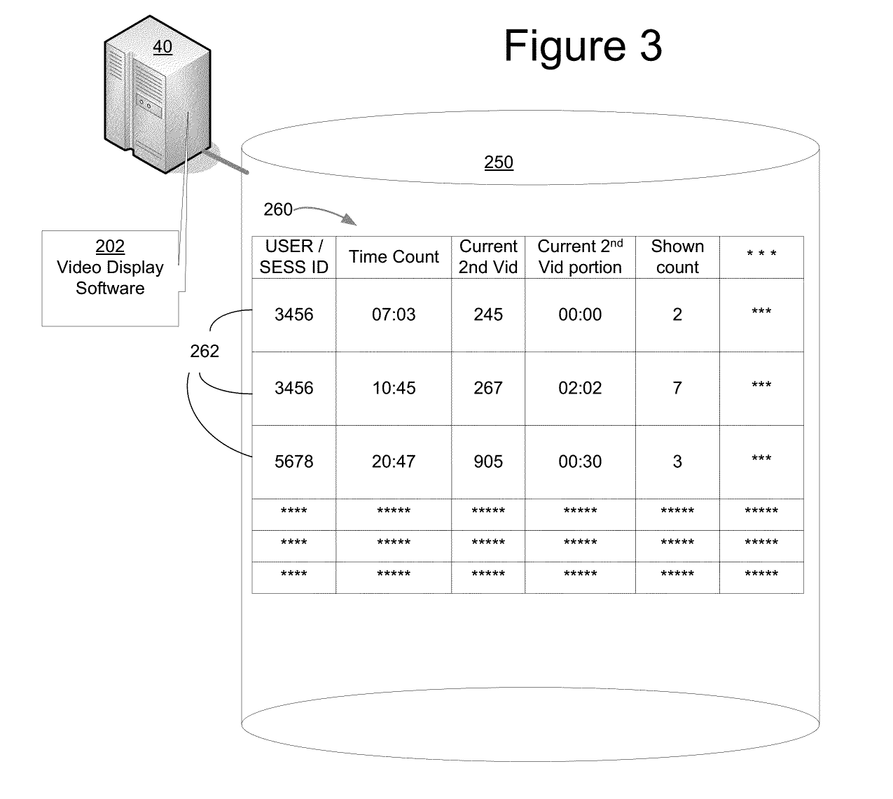

With reference to FIG. 3, a diagrammatic representation of the one or more servers 40, and a storage device 250, is shown. As indicated above, the server 40 may have executing within it video display software 202. The video display software 202 may comprise instructions to retrieve and display videos from the first video storage device 72 according to requests received by users 10. The storage devices 250 may store one or more databases to manage presentation of the second videos within the showing of the first videos. An exemplary database table 260 is shown in FIG. 3 illustrating some of the electronic data that may be stored and transformed to managing second video playback within presentation of the first videos. For example, each record of table 260 may contain user identification data so the number of impressions of each second video can be tracked for each user. This can be useful, for example, when the second videos comprise advertisements, and the web server owner is paid for the number of presentations of the second videos to selected user profiles.

In this regard, the web server owner, or owners of the second videos, may require that certain second videos be shown a certain number of times to each or certain users 10, and thus, included in each record 262 of the table 260 may be an impression or shown count field for each video identifier identified in a current second video field. This and other data in the record 262 may be referred to as consumption metadata. Further, each record 262 may contain a current second video portion field to keep track of the last portion of the second video that the user 10 has seen of the second video. In one embodiment, the current second video portion may serve to continue showing of the second video at the spot where a user paused or ended showing of the second video, even if the user tries to view a different first video. Thus, this feature may prevent an attempt by a user to avoid viewing of the second video, essentially preventing skipping of the second video. Alternatively, the user, or the server 40, may determine that the advertisement should be presented from the start sometimes, or each time. This may be useful, for example, wherein the second video is an advertisement, assuring the advertisement owner that the advertisement will be shown to users in full, even if in piecemeal as users stop and start viewing of the first videos that users may select.

Further, a record 262 may comprise a time count field that keeps track of the time viewed of one or more portions of the first videos. This feature may allow a user 10 to view at least some portions of the first videos that the user 10 may search for and select for viewing, without the need to be presented with one or more second videos. As an example, and not by limitation, a first video to second video ratio may determine whether the user's viewing of the first video should be interrupted to show the one or more of the second videos to the user 10, or a second video queued to be shown before another first video is presented. Thus, by way of example and not by way of limitation, as discussed above, such a feature may make interrupted presentations of a first video selected by a user for advertisement-type second videos more tolerable to the user 10.

In one embodiment, the first video time to second video presentation ratio may be as simple as a hard count for the number of minutes that a user may be shown a first video before a second video is presented. By way of example, and not be way of limitation, for example, a user watching a first video involving a football replay may be interrupted every 10 minutes of viewing by a second video containing an advertisement. If the user tries to cut viewing of the second video, then the next time the user attempts to view either the continuation of the same first video, or another of the first videos, then the advertisement will continue where the user left off (because the data is transformed in record 262 to keep track of the second video portion viewed in the current second video portion field). However, in one embodiment, the advertiser or owner of the server may wish the user 10 to view the second video from the start instead of where the last viewing of the second video left off, in which case, the second video is restarted upon presentation to the user 10. In one embodiment, a state field of the database record 262 may be transformed to reflect whether a second video finished presentation (F) or did not finish presentation (NF). Once the user has completed viewing of the second video in its entirety, then viewing of the selected first video or videos may continue.

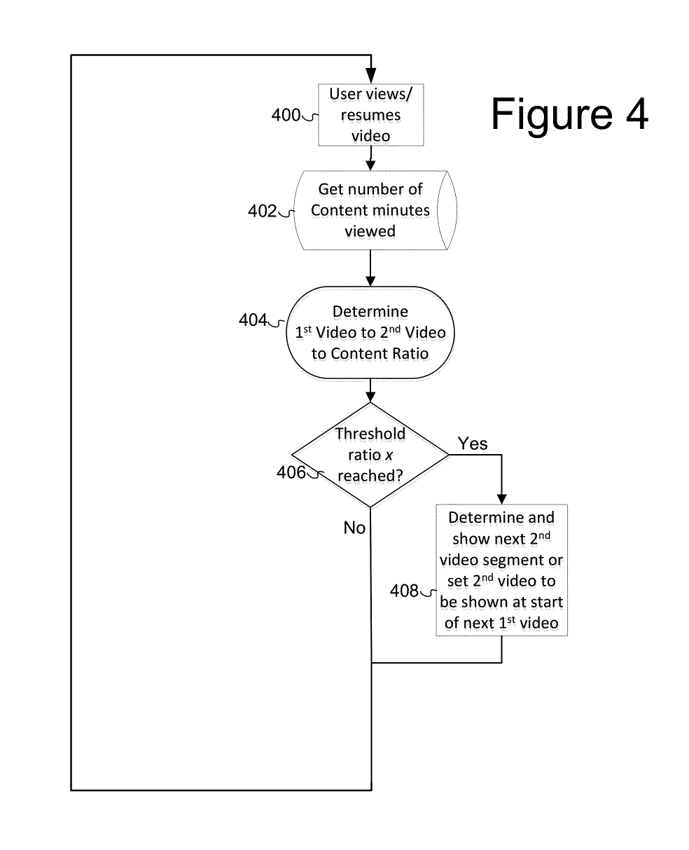

With reference to FIG. 4, a flow chart illustrates steps performed by the video display software 202 according to the embodiment of FIGS. 1-3. In step 400, a user 10 may select one or more of the first videos for viewing or resume reviewing. As the user continues viewing, in step 402, the video display software reads, records, and transforms the data in database 260, to determine a first video time viewed to second video presentation ratio in step 404. In step 406, the video display software 202 may determine whether a threshold ratio x is reached. If so, then in step 408, the video display software 202 may read the database 260 to determine what is the next video portion to be displayed of the one or more second videos, and interrupt to presentation of the first video to display the next portion of the second video at one or more selected break points of the first video. In one embodiment, the first video is not interrupted, and the second video, or segments of the second video, are only show at the beginning of the next time a user 10 views one of the first videos. In such an embodiment, step 404 may be delayed until after complete of presentation of the first video before the next first video is shown. Finally, in some embodiments, instead of presenting or showing segments of the second video at a time, the entire second video may be presented from the beginning for continuity. If result of step 406 is negative, processing them moves back to step 400 for the user 10 to continue viewing of the selected one or more first videos.

It should be noted that while examples related to advertisement-type videos may have been used, those of skill in the art may now recognize that many types of second videos may be presented using embodiments described here. By way of further example, and not by way of limitation, the second videos may comprise public service announcements, AMBER ALERTS, or other useful content. As a further example, the second videos may be related to the first videos, for example providing information on product placements in the first videos, or further information about actors, plots, or characters in the first videos.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. A system for presenting a second video with presentation of a first video, comprising:
a server connected to a network, the server comprising a processor;
a video management database in communication with the server, the video management database containing transformable electronic video management data;
a video management software program configured to present the first and second videos and transform the electronic video management data in the database depending on the presenting of the first and second videos;
a first set of instructions in the software program executable on the processor for recording a duration of time for viewing of the first video by transforming the electronic video management data in the database to produce a recorded duration; and
a second set of instructions in the software program executable on the processor for presenting the second video depending on the recorded duration.

2. The system of claim 1, wherein the second set of instructions is further executable to calculate a ratio of duration of presentation time of the first video compared to presentation of the second video on which the presentation of the second video is dependent.

3. The system of claim 1, wherein the second set of instructions are further executable to to present the second video before the presentation of the first video.

4. The system of claim 1, wherein the second set of instructions are further executable to to present the second video after presentation of the first video.

5. The system of claim 1, wherein the second set of instructions are further executable to interrupt presentation of the first video to present the second video.

6. The system of claim 1, wherein the second video comprises an advertisement.

7. The system of claim 1, wherein the second video comprises information regarding the first video.

8. The system of claim 1, wherein the second video comprises a public service announcement.

9. A system for presenting a plurality of second videos with presentation of a plurality of first videos, comprising:
a server connected to a network, the server comprising a processor;
a video management database in communication with the server, the video management database containing transformable electronic video management data;
a video management software program configured to present at least one of the first videos and at least one of the second videos, and to transform the electronic video management data in the database depending on the presenting of the at least one first video and the at least one second video;
a first set of instructions in the software program executable on the processor for recording a duration of time for viewing of the at least one first video by transforming the electronic video management data in the database to produce a recorded duration; and
a second set of instructions in the software program executable on the processor for presenting the at least one second video depending on the recorded duration.

10. A method for presenting a second video with presentation of a first video, comprising:
storing a video management database in communication with a server, the video management database containing transformable electronic video management data;
presenting the first and second videos and transforming the electronic video management data in the database depending on the presenting of the first and second videos;
recording a duration of time for viewing of the first video by transforming the electronic video management data in the database to produce a recorded duration; and
presenting the second video depending on the recorded duration.

11. The method of claim 10, further comprising calculating a ratio of duration of presentation time of the first video compared to presentation of the second video on which the presentation of the second video is dependent.

12. The method of claim 1, comprising presenting the second video before the presentation of the first video.

13. The system of claim 1, comprising presenting the second video after presentation of the first video.

14. The method of claim 10, further comprising interrupting presentation of the first video to present the second video.

15. The method of claim 10, wherein the second video comprises an advertisement.

16. The method of claim 10, wherein the second video comprises information regarding the first video.

17. The method of claim 10, wherein the second video comprises information regarding the first video.

18. The method of claim 10, wherein the second video comprises a public service announcement.

19. A system for presenting a plurality of second videos with presentation of one or more first videos, comprising:
a server connected to a network, the server comprising a processor;
a video management database in communication with the server, the video management database containing transformable electronic video management data;
a video management software program configured to present at least one of the first and an n number of second videos, and to transform the electronic video management data in the database;
a first set of instructions in the software program executable on the processor for recording a duration of time for viewing of the at least one first video by transforming the electronic video management data in the database to produce a recorded duration; and
a second set of instructions in the software program executable on the processor for presenting each of the n number of second videos depending on the recorded duration.
